(19) United States
(12) Patent Application Publication
(10) Pub. No.: US 2008/0207311 A1
(43) Pub. Date: Aug. 28, 2008

(54) METHOD FOR AN ONLINE PAY-TO-PLAY GAME OF SKILL

(76) Inventors: Tamir Levinas, Tel Aviv (IL); Haoz Locwenstein, Kadima (IL)

Correspondence Address: Naomi Assia Law Offices;C/O Landon IP Inc., Suite 450, 1700 Diagonal Road, Alexandria, VA, 22314, US

(21) Appl. No.: 11/678,630

(22) Filed: Feb. 26, 2007

(51) Int. Cl. A63F 13/00

(52) U.S. Cl. 463/26

(57) ABSTRACT

A method for an online game run by a house proprietor. The method includes logging on by a game player. Then the game player chooses a game arena. Subsequently, the game player and the other game players in said arena pay into the pot. Then the house proprietor takes a percentage. Finally, the remainder of the pot is received by the winner of the online game.

### FIELD OF THE INVENTION

The present invention relates to method for online gaming, and more particularly to a method for an online pay-into-the-pot game of skill, wherein the winner takes the pot, minus the house percentage and clearing commission.

### BACKGROUND OF THE INVENTION

According to estimates, by 2008 as much as half of the U.S population will be playing at least one Online-Game (OLG). The OLG industry can be divided into several genres, the more popular being First Person Shooter (FPS) and Sports Based games, such as racing and ball games. These games require elements of speed, competitiveness and specialty on the part of their gamers. (First person shooter games have made for good press coverage.)

According to Justin Hall's Web site, most online games are “third person,” meaning you see your character as you act for that character. Alternatively, a player is some kind of disembodied person who hovers g-dlike above the playing field.

In first person shooters, the screen is like one's eyes. At the bottom of the screen is the weapon one is wielding. When combined with freedom of motion, i.e., no movement “track,” first person shooter games can be extremely immersive.

In recent history, the development of FPS shooters has followed a pattern. A software company develops an “engine,” meaning a software platform for graphics and game-play. The company then releases a “pure” FPS with the engine, such as Unreal™ and Quake™. Players of this FPS game get acquainted with the platform potential and this often leads to further development on the platform. The software company usually licenses the engine to develop more plot-heavy games, often merging FPS with adventure or role-playing.

Games like Quake III: Arena™ and Unreal Tournament™ are immensely popular as 3D environments where people share space. Games like Half-Life™, built on the Quake™ engine, and Deus EX™, built on the Unreal™ engine, take the immersion offered by first person environments and push the boundaries of computer storytelling.

Prior art FIG. 1a shows that there are over 5 million registered players, paying to play the various OLG's. The number of subscribers 101 is plotted against time 102 from 1997 to 2005.

Thus, it would be desirable to have an online game methodology wherein the billing is convenient and is seamless to the user.

### SUMMARY OF THE INVENTION

Accordingly, it is a principal object of the present invention to provide a method for online games wherein billing is convenient and seamless to the user.

It is another principal object of the present invention to provide a method that answers two basic needs, the need to compete and the need for award winning competition.

A method is disclosed for providing online games run by a house proprietor. The method allows a game player to log onto a game provided by the house proprietor. The game player then chooses a game arena in which to play a certain game. Depending on his choice, he can play against one or multiple adversaries. Subsequently, the game player and the adversary/adversaries pay into the pot. The house proprietor takes a percentage of the pot and the remainder of the pot is received by the winner of the game.

The heart of this model is the assumption that one can combine Online Games with the experience of victory and a prize, and thereby create a ‘ring’ comprising gamers who pay for the right to compete, and are rewarded with money when victorious. The host (the house proprietor) for this ring receives a commission from the gamers.

Gamers will be able to play against a single, or multiple competitor(s). The present invention combines OLG with a financial element. Gamers pay for the right to participate in a single game, and the winner gets the jackpot. The house retains a commission from each gamer.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

Prior art FIG. 1a shows that as of 2005 there were over 5 million registered players paying to play the various OLG's.

FIG. 1b is an exemplary flowchart of the online game, according to the principles of the present invention; and

FIG. 2 is a set of schematic images representing the steps in the online game of the present in invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

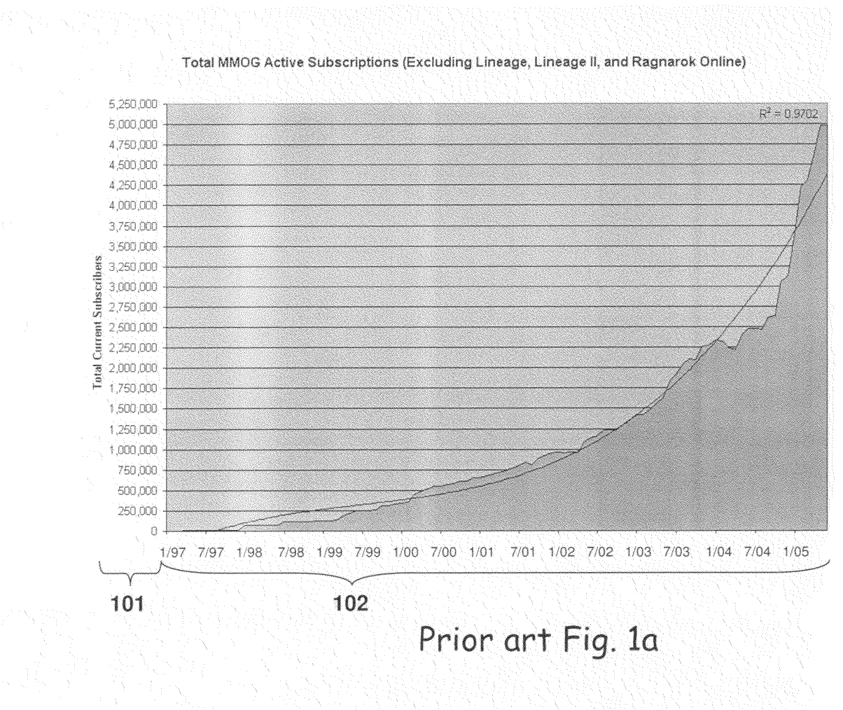

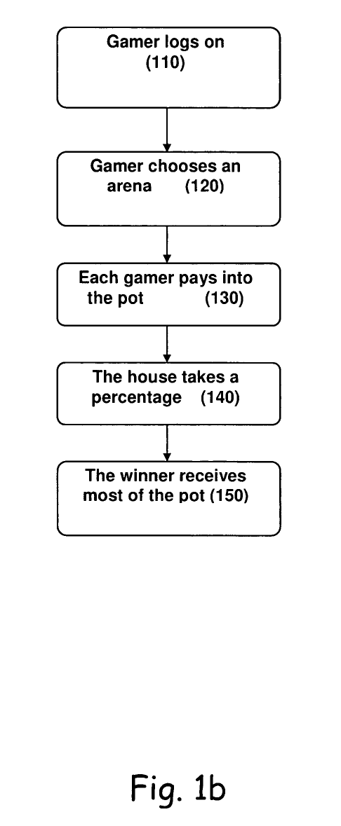

Reference is now made to FIG. 1b, an exemplary flowchart of the online game, according to the principles of the present invention. The method for the online game run by a house proprietor is shown in FIG. 1b. First, a game player logs on 110. Then the game player chooses a game arena 120. Subsequently, the game player, together with the other game player(s) in the arena, pay into the pot 130. The house proprietor then takes a percentage 140. Finally, the remainder of the pot is received by the winner of the online game 150.

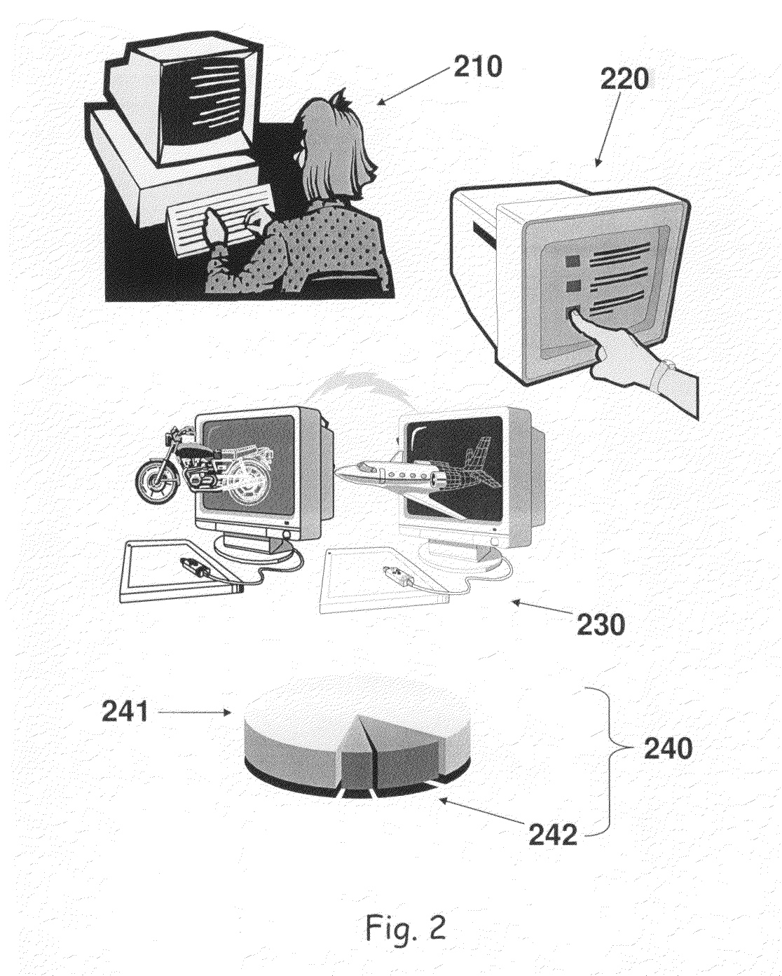

FIG. 2 is a set of schematic images representing the steps in the online game of the present invention. First, a player is shown logging on to the game 210. Then the game player chooses a game arena 220. The game player, together with the other game player(s) in the arena, pay into the total pot 240. Subsequently, the game player and the adversary/adversaries play the game 230. Then the house proprietor takes a percentage 241). Finally, the remainder of the pot 242 is received by the winner of the online game

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for an online game run by a house proprietor comprising:
logging on by a game player;
one of:
choosing of a game arena by said game player comprising at least one other game player; and
setting up new arena where other players can join (as mentioned above)
paying into the pot by said game player and the at least one other game player in said arena;
taking a percentage by said house proprietor;
receiving of the remainder of said pot by the winner of the online game.

2. The method of claim 1, wherein the amount paid into said pot by said game player and said adversary is $5 (five) each.

3. The method of claim 1, wherein the percentage taken by said house proprietor is 20%.

4. The method of claim 1, wherein the percentage won is 80%.

5. The method of claim 1, further comprising paying a clearing commission by said house proprietor.
